(19) United States
(12) Patent Application Publication
(10) Pub. No.: US 2022/0217940 A1
(43) Pub. Date: Jul. 14, 2022

(54) ANIMAL FEEDING APPARATUS

(71) Applicant: Patrick James Sevigny, Lubbock, TX (US)

(72) Inventor: Patrick James Sevigny, Lubbock, TX (US)

(21) Appl. No.: 17/144,888

(22) Filed: Jan. 8, 2021

(51) Int. Cl. A01K 1/10

(52) U.S. Cl. CPC A01K 1/105

(57) ABSTRACT

An animal feeder includes a wall at least partially defining a feed storage compartment. The wall includes a layer of louvers that permit air flow to and from the feed storage compartment and a layer of mesh to prevent insects from entering the feed storage compartment.

### TECHNICAL FIELD

This disclosure relates to apparatuses for the feeding of deer and similar animals.

### BACKGROUND

Animal feeders are sometimes used to provide nourishment to various animals, such as deer, elk, etc., and to draw them to a predetermined location for observation, harvesting, etc. Some animal feeders include a container configured to store animal food, such as grain, pellets, etc., and a dispenser that releases the animal food from the container. Typically, the container and the dispenser are supported above the ground by a plurality of support members in a tripod arrangement.

### SUMMARY

A feeder includes at least one vertical wall defining a feed storage compartment, and structure defining the lower surface of the feed storage compartment. The at least one vertical wall has a first layer comprising angled louvers and a second layer comprising mesh screen. The louvers permit air flow through the feed storage compartment, thereby preventing the overheating of the feed contained therein due to solar heating and allowing for the elimination of any excess moisture that is released by the feed. The mesh retains the feed in the compartment and prevents insects from entering the compartment while not interfering with the air flow. Accordingly, the feeder provided herein prevents the growth of mold and the spoilage of feed stored therein.

The feeder provided herein may also include a novel lower surface of the feed storage compartment that is inclined on all sides of an opening to a passageway that leads to a feed distributor. The lower surface design facilitates the gravity-induced granular flow of feed. The feeder may also include a hollow floor through which wires extend to power lights that are integrated into the bottom of the feeder to illuminate any animals that are feeding beneath the feeder.

The above features and advantages and other features and advantages of the present disclosure are readily apparent from the following detailed description of the best modes for carrying out the disclosure when taken in connection with the accompanying drawings

### BRIEF DESCRIPTION OF THE DRAWINGS

FIG. 1 is a schematic, perspective view of an animal feeder apparatus including a stand supporting an animal feeder having an expanded metal platform in a horizontal position;

FIG. 2 is a schematic, perspective view of the animal feeder apparatus of FIG. 1 with the expanded metal platform in a vertical position;

FIG. 3 is a schematic, sectional, side view of the feeder of FIG. 1, including structure and walls cooperating to define compartments;

FIG. 4 is a schematic, perspective view of a portion of the structure;

FIG. 5 is a schematic, top view of the structure of FIG. 4;

FIG. 6 is a schematic, perspective view of the feeder with the lid in an open position;

FIG. 7 is a schematic, perspective view of the feeder with a storage compartment door in an open position; and

FIG. 8 is a schematic, bottom view of the feeder.

### DESCRIPTION OF THE PREFERRED EMBODIMENTS

Referring to the Figures, wherein like reference numbers refer to like components throughout, an animal feeder apparatus 10 includes an animal feeder 14 and a stand 18. In the embodiment depicted, the stand 18 includes four substantially vertical support members 22 and four substantially horizontal support members 26, 30 that operatively interconnect the top ends of the vertical support members 22. The feeder 14 rests on the horizontal support members 26, 30 so that the stand 18 supports the feeder 14 above the ground. The space between the horizontal support members 26, 30 is open and unobstructed.

It should be noted that the stand 18 in the embodiment depicted is merely exemplary and that any stand configuration that adequately supports the feeder 14 without interfering with its operation may be employed within the scope of the claimed invention. Optional tie-downs are used in the embodiment depicted to interconnect the ground with the top of the stand 18 or the feeder 14 to provide additional stability to the apparatus 10.

The feeder 14 includes four vertical walls 34A, 34B, 34C, 34D, and a lid 38 that cooperate to partially define a first storage compartment 42. The feeder 14 also includes structure 46 defining the lower surface 48 of the first storage compartment. Three of the walls 34A, 34B, 34C are comprised of three layers: a first layer 52 comprising angled louvers 56, a second layer 58 comprising coarse mesh screen 60, and a third layer 62 comprising fine mesh screen 64.

The first layer 52 is the outermost layer of walls 34A, 34B, 34C, the third layer 62 is the innermost layer, and the second layer 58 is between the first and third layers. The louvers 56 are angled such that, in any given wall, the innermost edge of each louver is higher than the outermost edge of each louver. The louvers 56 are spaced apart from each other in the vertical direction such that there is space between each louver 56 and any adjacent louvers 56.

The first storage compartment 42 is configured to store the animal feed that is dispensed from the feeder 14. Typically, the animal feed is corn but could be any feed within the scope of the claimed invention, including, but not limited to, feed cubes. The construction of walls 34A, 34B, 34C prevents spoilage of the feed contained within the first storage compartment 42. More specifically, the louvers 56, with the spaces therebetween, permit air flow between the first storage compartment 42 and the surrounding environment, while the angle of the louvers 56 limits or prevents rain from entering the first storage compartment. The air flow enabled by the louvers 56 prevents overheating of the feed due to solar heating of the feeder 14 by enabling convective heat transfer from the compartment to the surrounding atmosphere. The air flow enabled by the louvers 56 also facilitates the elimination of water or water vapor that may be released from the feed, thereby preventing the clumping of the feed and the growth of mold.

The fine mesh screen 64 of the third layer 62 prevents insects from entering the first storage compartment 42 while also not blocking the air flow. The coarse mesh screen 60 of the second layer 58 protects the fine mesh screen 64 from being torn by animals such as racoons. The coarse mesh screen 60 may also assist the fine mesh screen 64 in retaining the feed inside the first storage compartment 42. In one embodiment, the coarse mesh screen is a quarter-inch mesh. The mesh screens 60, 64 may be any material within the scope of the claimed invention, including, but not limited to, various metal screens and plastic mesh screens.

In the embodiment depicted, wall 34D does not include the three-layer construction of walls 34A-C. Instead, the wall 34D is a single, solid, continuous piece of material such as plywood, which permits the attachment of various accessories such as a photovoltaic panel 66. It should be noted that, within the scope of the claimed invention, at least one of the walls 34A-D has the three-layer construction. Thus, for example, and within the scope of the claims, only one wall may have the three layers 52, 58, 62 or all of the walls may have the three layers 52, 58, 62. Similarly, although the feeder 14 in the embodiment depicted includes four walls 34A-D, a feeder 14 within the scope of the claims may have more walls or fewer walls. For example, and within the scope of the claimed invention, a feeder may have a single cylindrical wall defining a cylindrical feed storage compartment.

The lower surface 48 of the first storage compartment 42 defines a valley 68. A conduit 72 for directing feed from the first storage compartment 42 defines a passageway 76 having a first opening 78 and a second opening 82. The first opening 78 is in the valley 68 at the lowest extent of the valley 68.

More specifically, the lower surface 48 includes a first linear edge 86 and a second linear edge 90 spaced apart from and parallel to the first linear edge 86. The first and second linear edges 86, 90 extend substantially the entire width of the first storage compartment 42. The lower surface 48 includes a first substantially planar portion 94 that inclines upward from the first edge 86, and a second substantially planar portion 98 that inclines upward from the second edge 90. The lower surface 48 also includes a first vertical portion 102 that extends downward from the first edge 86 and a second vertical portion 106 that extends downward from the second edge 90.

The lower surface 48 also includes a third substantially planar portion 110 that is between the first and second vertical portions 102, 106 and inclines upward from the first opening 78 of the first passageway 76 on a first side of the first opening 78. The lower surface 48 further includes a fourth substantially planar portion 114 that is between the first and second vertical portions 102, 106 and inclines upward from the first opening 78 of the first passageway 76 on a second side of the first opening 78 opposite the first side.

The first storage compartment 42 is thus symmetrical about a first vertical plane that bisects the compartment 42 and is also symmetrical about a second vertical plane perpendicular to the first vertical plane. The vertical portions 102, 106, and third and fourth planar portions 110, 114 define the valley 68 and are at such a steep incline that virtually all of the feed contained within the valley 68 is gravity fed into the passageway 76. The first and second planar portions 94, 98, which are above the valley 68, are sufficiently inclined such that all feed in the storage compartment 42 is gravity-fed into the valley 68. The vertical portions 102, 106 are on two opposing sides of the opening 78, and the steep planar portions 110, 114 are on the other two opposing sides of the opening 78. Wall 34B includes a transparent sight glass 116 that extends from the top of the compartment 42 to the top of the valley 68 so that the amount of feed in the compartment 42 is observable from the exterior of the feeder 14.

In the embodiment depicted, the feeder 14 includes a plurality of support members 117 that are attached to the first and second substantially planar portions 94, 98 of the lower surface 48. The support members 117 are parallel to one another and act to reinforce the structure that defines the surface portions 94, 98 and thereby prevent sagging of the structure due to the weight of the feed resting thereon. The support members 117 form protuberances from the surface portions 94, 98, and cooperate with the portions 94, 98 to define a plurality of grooves 119. The members 117 and the grooves 119 are oriented such that the support members 117 and the protuberances that they form do not interfere with the gravity-fed granular flow of feed from portions 94, 98 into the valley 68.

It should be noted that, as used herein, a “substantially planar portion” of a surface may include protuberances that are oriented such that the protuberances do not substantially interfere with the gravity-induced flow of material on the substantially planar portion. The protuberances may be formed by members attached to the surface, as shown in the embodiment depicted, or may be formed by the structure defining the surface. For example, in an alternative embodiment (not shown) and within the scope of the claimed invention, the structure 48 may define corrugations, i.e., alternating and parallel grooves and protuberances, in surface portions 94, 98 that are oriented so as not to substantially interfere with gravity-induced flow on the surface portions 94, 98.

The structure 46 also cooperates with the walls 34A-34D to define a second storage compartment 118 under the first substantially planar portion 94 and to define a third storage compartment 122 under the second substantially planar portion 98. The second and third storage compartments 118, 122 are separated by the valley 68 and the portion of the structure that defines the valley 68.

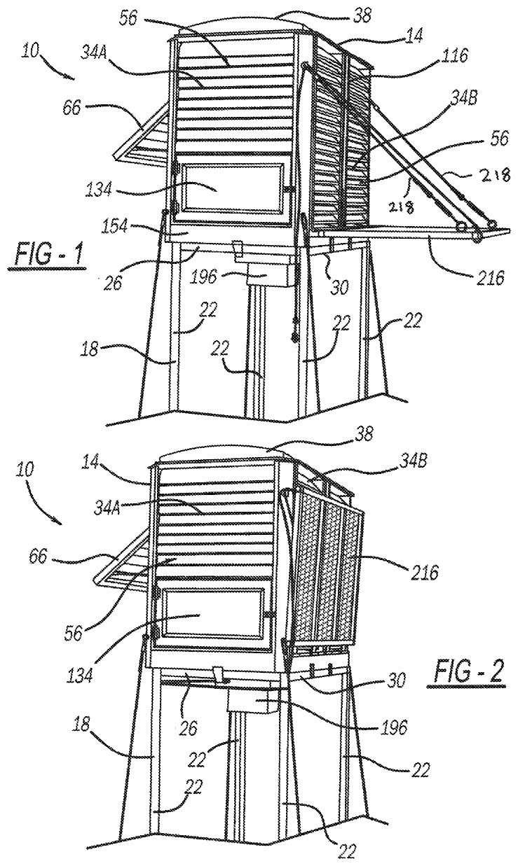

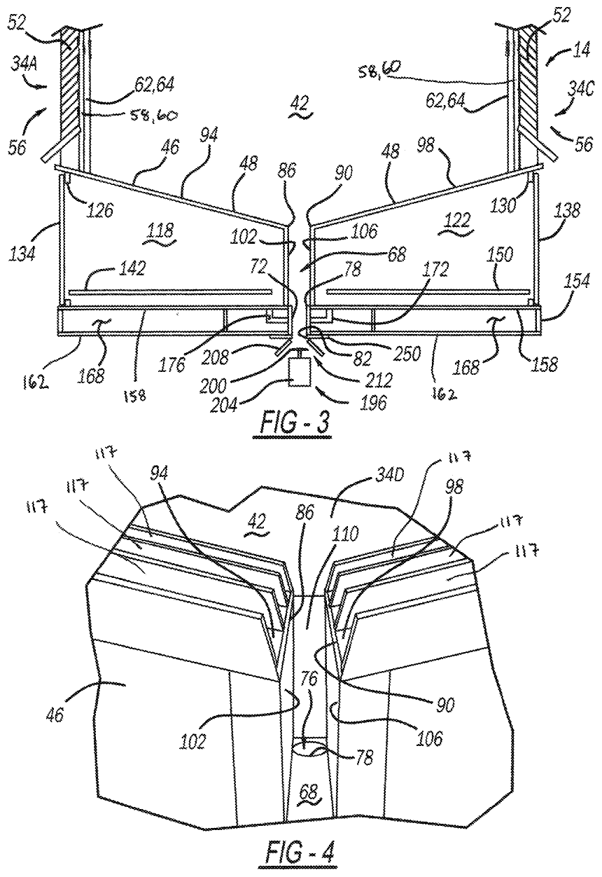

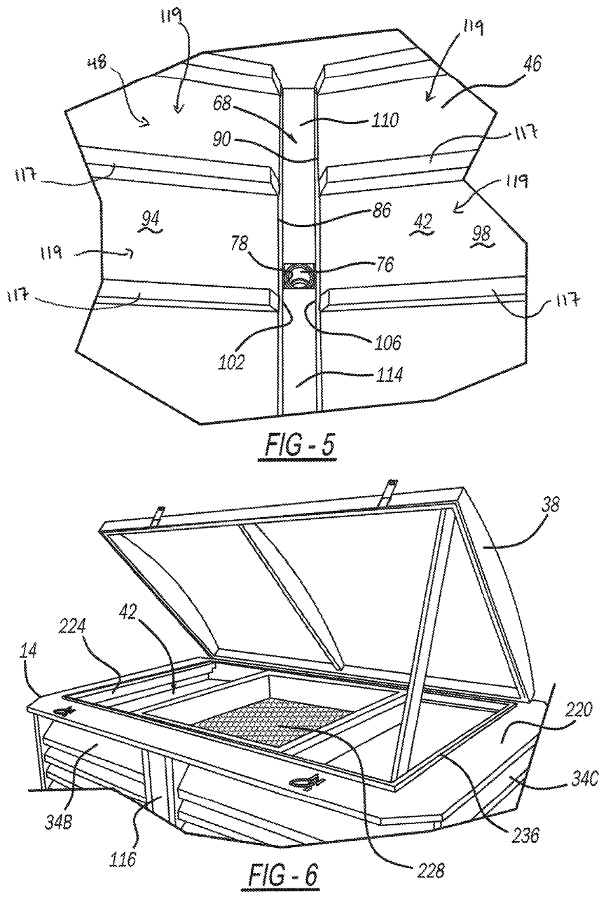

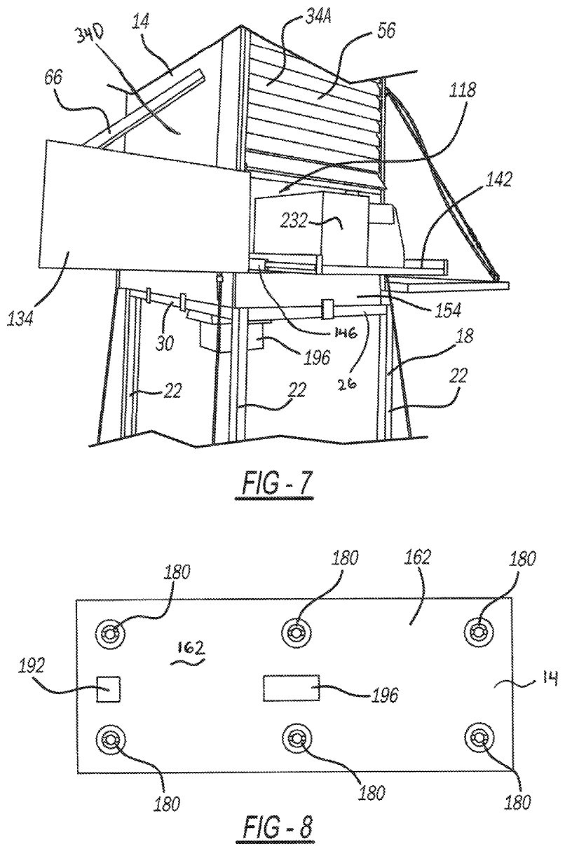

One of the walls 34A defines a first opening 126 to the second storage compartment 118, and another one of the walls 34C defines a second opening 130 to the third storage compartment 122. The feeder 14 further comprises a first door 134 movably mounted with respect to the wall 34A and configured to selectively obstruct the first opening 126. A second door 138 is movably mounted with respect to the wall 34C and configured to selectively obstruct the second opening 130. More specifically, the first and second doors 134, 138 are connected to their respective walls 34A, 34C via hinges such that each of the doors 134, 138 is selectively rotatable between open and closed positions. The doors 134, 138 are shown in the respective closed positions in FIG. 3. Door 134 is also shown in the closed position in FIGS. 1 and 2, and door 134 is shown in the open position in FIG. 7.

The feeder 14 includes a first shelf 142 disposed within the second compartment 118 and is selectively movable between a retracted position in which the first shelf 142 is entirely within the second compartment 118, as shown in FIG. 3, and an extended position in which the first shelf 142 extends out of the second compartment 118 through the first opening 126, as shown in FIG. 7. In the embodiment depicted, the first shelf 142 is mounted to feeder 14 via drawer glides 146 as seen in FIG. 7.

Similarly, a second shelf 150 is disposed within the third compartment 122 and is selectively movable between a retracted position in which the second shelf 150 is entirely within the third compartment 122 and an extended position in which the second shelf 150 extends out of the third compartment 122 through the second opening 130.

A bottom portion 154, or base, of the feeder 14 extends under the first, second, and third compartments 42, 118, 122. The bottom portion 154 includes a first panel 158 and a second panel 162. The first and second panels 158, 162 are substantially horizontal, parallel to one another, and define a first chamber 168 therebetween. The first conduit 72 extends through the first chamber 168.

A second conduit 172 defines a second passageway 176. The second conduit 172 and the second passageway 176 extend through the first chamber 168 from the second compartment 118 to the third compartment 122. Wires may extend through the passageway 176 of the conduit thereby to electrically interconnect components that are disposed within the second compartment 118 with components in the third compartment 122. As shown in FIG. 8, a plurality of lights 180 are built into the second panel 162 such that the lights 180 shine downward to illuminate the ground under the feeder 14 for viewing animals that are feeding. More specifically, the second panel 162 defines a plurality of holes; each of the lights 180 extends through a respective one of the holes. Wires (not shown) are routed from the components in the second compartment 118 through the first chamber 168 to the lights 180. Accordingly, the bottom portion 154 of the feeder 14 enables the lights 180 to be integrated with the feeder 14 and powered and controlled by the components stored in the second compartment 118 by accommodating the electrical interconnection between the lights 180 and the control and power components in the chamber 168.

Each of the lights 180 is selectively rotatable about a respective horizontal axis and a respective vertical axis so that the area of illumination can be modified by a user. In one embodiment, the lights 180 are LEDs. At least one electrical outlet 192 is mounted to the second panel 162 so that the user may connect other devices to the feeder's battery.

A feed dispenser assembly 196 includes a feed distributor 200 and a motor 204 operatively connected to the feed distributor 200 such that the motor selectively rotates the feed distributor 200. The distributor 200 is positioned under the second opening 82 to the passageway 76. Thus, feed from the first storage compartment 42 is gravity fed through the passageway 76 and onto the distributor 200. The spinning distributor transmits horizontal forces to the feed in order to distribute the feed broadly across the ground under the feeder 14.

The feeder includes a skirt 208 that defines a second chamber 212 that is downwardly open. The distributor 200 is disposed within the second chamber 212. The second chamber 212 is tapered such that the second chamber increases in width in the downward direction as shown in FIG. 3. The walls of the skirt 208 surround the distributor 200 and prevent the feed from being scattered over a wide area. Thus, the skirt 208 maintains the feed in the area beneath the feeder 14 that is illuminated by the lights 180.

Referring specifically to FIGS. 1 and 2, an expanded metal platform 216 is rotatably connected with respect to one wall 34B for movement between a vertical position, as shown in FIG. 2, and a horizontal position, as shown in FIG. 1. The platform 216 in the horizontal position provides a structure to support a user while loading feed into the compartment 42. The expanded metal platform 216 defines a plurality of apertures throughout, thereby enabling a user to view the sight glass 116 through the platform 216 when the platform 216 is in the vertical position. In the embodiment depicted, the platform 216 is connected to the wall 34B via at least one hinge, and flexible members 218, such as ropes or cables, interconnect the platform 216 and the top of the feeder 14 to support the platform 216 in the horizontal position as shown.

Referring to FIG. 6, the upper surface 220 of the feeder 14 defines an opening 224 to the first compartment 42. The lid 38 is mounted with respect to said at least one wall such that the lid is selectively movable between a closed position, as shown in FIGS. 1 and 2, in which the lid 38 obstructs the opening 224, and an open position, as shown in FIG. 6, in which the lid 38 does not obstruct the opening 224. The feeder 14 includes a sieve 228 extending across at least a portion of the opening 224. The sieve 228 is selectively slidable relative to the opening 224. A lip 236 surrounds the opening 224 to keep rain from the lid 38 from entering the first compartment 42. The outer surface of the lid 38 is convex to prevent water from pooling thereon.

It should be noted that compartment doors 134, 138 and the lid 38 have weather strip on them to keep rain and insects out. The feeder 14 in the embodiment shown has the general shape of a rectangular prism, and is approximately 2 feet deep, 4 feet wide, and 3.5 feet tall. It holds 700 pounds of feed. However, other shapes and dimensions of the feeder 14 may be employed within the scope of the claimed invention.

In the embodiment depicted, the louver 56 directly above the doors 134, 138 are longer than the other louvers to prevent rain from entering the compartments.

The feeder 14 includes a marine battery 232 that is operatively connected to the lights 180 and motor 204. The battery 232 is disposed on the shelf 142 in the second storage compartment 118. Other devices stored on the shelf 142 in the second storage compartment 118 may include a timer for a control unit that is operatively connected to the motor 204 such that the feeder 14 may be programmed to dispense feed at predetermined times or intervals. The timer is at eye level and removable from the shelf 142 so that it can be held at waist level which makes it easy to adjust feed times. Prior art timers are usually located inside the control unit under the feeder, which means that a user must crawl under the feeder to adjust the timer. Toggle switches to control the lights 180 may also be on the shelf 142 in the second compartment 118, as well as a charge controller for the solar panel 66, which is connected to the battery 232. An LED gooseneck light is mounted to the shelf 142 so that the compartment can be illuminated.

The third compartment 122 may be used to store another battery, which can be electrically connected to the other devices, such as a charge controller and electrical panel, in the second compartment 118 through the conduit 172 that interconnects the second and third compartments 118, 122. Alternatively, the third compartment 122 may be used to store tools.

A slide valve 250 is mounted to the second panel 162 and is positioned to control the flow of feed from the conduit 72. Without the slide valve 250, the feed contained in the first compartment 42 would immediately be drained if the control unit (feed dispenser assembly) 196 is removed for servicing. The skirt 208 is also selectively removable.

While the best modes for carrying out the invention have been described in detail, those familiar with the art to which this invention relates will recognize various alternative designs and embodiments for practicing the invention within the scope of the appended claims.

1. A feeder comprising:
at least one vertical wall defining a first storage compartment; and
structure defining a lower surface of the first storage compartment;
said at least one vertical wall having a first layer comprising angled louvers and a second layer comprising mesh screen.

2. The feeder of claim 1, wherein said at least one vertical wall has a third layer comprising mesh screen; and
wherein the mesh screen of the third layer is finer than the mesh screen of the second layer.

3. The feeder of claim 2, wherein said at least one vertical wall includes four vertical walls defining an interior space therebetween;
wherein the lower surface of the first storage compartment defines a valley;
wherein the feeder further comprises a first conduit defining a first passageway having a first opening and a second opening; and
wherein the first opening is in the valley.

4. The feeder of claim 3, wherein the lower surface includes a first linear edge and a second linear edge spaced apart from and parallel to the first linear edge;
wherein the first and second linear edges extend substantially the entire width of the first storage compartment;
wherein the lower surface includes a first substantially planar portion that inclines upward from the first edge; and
wherein the lower surface includes a second substantially planar portion that inclines upward from the second edge.

5. The feeder of claim 4, wherein the lower surface includes a first vertical portion that extends downward from the first edge;
wherein the lower surface includes a second vertical portion that extends downward from the second edge;
wherein the lower surface includes a third substantially planar portion that is between the first and second vertical portions and inclines upward from the first opening of the first passageway on a first side of the first opening; and
wherein the lower surface includes a fourth substantially planar portion that is between the first and second vertical portions and inclines upward from the first opening of the first passageway on a second side of the first opening opposite the first side.

6. The feeder of claim 4, wherein the structure cooperates with said walls to define a second storage compartment under the first substantially planar portion;
wherein the structure cooperates with said walls to define a third storage compartment under the second substantially planar portion.

7. The feeder of claim 6, wherein one of the walls defines a first opening to the second storage compartment;
wherein another one of the walls defines a second opening to the third storage compartment;
wherein the feeder further comprises a first door movably mounted with respect to the walls and configured to selectively obstruct the first opening; and
a second door movably mounted with respect to the walls and configured to selectively obstruct the second opening.

8. The feeder of claim 7, further comprising a first shelf disposed within the second compartment and being selectively movable between a retracted position in which the first shelf is entirely within the second compartment and an extended position in which the first shelf extends out of the second compartment through the first opening.

9. The feeder of claim 8, further comprising a second shelf disposed within the third compartment and being selectively movable between a retracted position in which the second shelf is entirely within the third compartment and an extended position in which the second shelf extends out of the third compartment through the second opening.

10. The feeder of claim 7, further comprising a bottom portion that extends under the first, second, and third compartments, said bottom portion including a first panel and a second panel; said first and second panels being substantially horizontal, parallel to one another, and defining a first chamber therebetween.

11. The feeder of claim 10, wherein the first conduit extends through the first chamber.

12. The feeder of claim 11, further comprising a second conduit defining a second passageway extending through the first chamber from the second compartment to the third compartment.

13. The feeder of claim 10, further comprising a plurality of lights built into the second panel; each of said lights being selectively rotatable about a horizontal axis and a vertical axis.

14. The feeder of claim 13, further comprising at least one electrical outlet mounted to the second panel.

15. The feeder of claim 13, further comprising a feed dispenser assembly including a feed distributor, a motor operatively connected to the feed distributor such that the motor selectively rotates the feed distributor, said distributor being positioned under the second opening to the passageway; and
a skirt defining a second chamber that is downwardly open;
said distributor being disposed within the second chamber.

16. The feeder of claim 15, wherein the second chamber is tapered such that the second chamber increases in width in the downward direction.

17. The feeder of claim 15, further comprising a slide valve mounted to the second panel and configured to selectively control the flow of feed from the first passageway.

18. The feeder of claim 1, further comprising an expanded metal platform being rotatably connected with respect to said at least one wall for movement between a vertical position and a horizontal position.

19. The feeder of claim 1, wherein the feeder defines an opening to the first compartment;
wherein the feeder further comprises a lid being mounted with respect to said at least one wall such that the lid is selectively movably between a closed position in which the lid obstruct the opening and an open position in which the lid does not obstruct the opening; and
a sieve extending across at least a portion of the opening.

20. The feeder of claim 19, wherein the sieve is selectively slidable relative to the opening.
